(19) United States
(12) Patent Application Publication
(10) Pub. No.: US 2003/0072377 A1
(43) Pub. Date: Apr. 17, 2003

(54) Method of detecting blocking artifacts

(76) Inventors: Vincent Ruol, Paris (FR); Arnaud Gesnot, Montigny le Bretonneux (FR)

Correspondence Address: U.S. Philips Corporation, 580 White Plains Road, Tarrytown, NY, 10591, US

(21) Appl. No.: 10/270,302

(22) Filed: Oct. 11, 2002

(30) Foreign Application Priority Data
Oct. 16, 2001 (FR) 0113330

(51) Int. Cl. H04N 7/12

(52) U.S. Cl. 375/240.27

(57) ABSTRACT

The present invention concerns a method of detecting blocking artifacts (10) from video data coded and then decoded according to a block coding technique. Said method comprises the steps of calculating a first discrete transformation (1) of a first video data segment (11), calculating a second discrete transformation (2) of a second video data segment (12), said second segment being adjacent to the first segment, and calculating a discrete transformation (4) of a concatenated video data segment (13) corresponding to the concatenation (3) of the first and second segments. It also comprises a step of calculating (5) a blocking artifact level (17) from the content of the first and segments of transformed video data (14, 15), and the concatenated segment of transformed video data (16). In this way a very precise blocking artifact detection method is obtained, able to be used in a post-processing or coding of the video data.

### FIELD OF THE INVENTION

The present invention concerns a method of detecting blocking artifacts from video data coded and then decoded according to a block-based coding technique.

It finds in particular its application in video compression, the compression technique being based for example on the MPEG (Moving Pictures Expert Group) standard, with a view to correcting said artifacts by means for example of post-processing or improved coding of the video data.

### BACKGROUND OF THE INVENTION

The video compression algorithms using block-based coding techniques sometimes result in a degradation of the visual quality of the coded and then decoded images. One of the visual artifacts most usually observed with these coding techniques is referred to as a blocking artifact. The degradation of the visual quality can range from an imperceptible level to a level which is very annoying to the viewer according to the coding rate used. These blocking artifacts are in particular due to the quantization of the blocks of DCT coefficients, which is all the coarser, the lower the coding rate.

International patent application WO 01/20912 (internal reference: PHF99579) describes a method of detecting blocking artifacts in a digital image containing pixels, said method comprising the steps of:

gradient filtering of luminance values of said pixels, supplying filtered data, horizontal yh and vertical yv,

calculating absolute values yah and yav of the filtered data,

calculating average values \overline{xaₕ} and \overline{xaᵥ} of the absolute values,

detecting a blocking artifact, here a vertical artifact if:

$$\{ \begin{matrix}{xa}_{h} [ n , j ] > {xa}_{h} [ n , j - 1 ] + \frac{\overline{{xa}_{h}}}{2} \\ {xa}_{h} [ n , j ] > {xa}_{h} [ n , j + 1 ] + \frac{\overline{{xa}_{h}}}{2}\end{matrix} ∀ n ∈ [ i , i + k ] with k greater than or equal to 7.$$

Such a method does however have the drawback firstly of not detecting all the blocking artifacts and secondly sometimes resulting in false detections. In addition, it detects only blocking artifacts whose size is at least 8 pixels.

### SUMMARY OF THE INVENTION

The purpose of the present invention is to propose a method of detecting blocking artifacts which is both more reliable and more precise.

To this end, the video data processing method according to the invention is characterized in that it comprises the steps of:

calculating a first discrete transformation of a first video data segment belonging to a first block,

calculating a second discrete transformation of a second video data segment belonging to a second block, said second segment being adjacent to the first segment,

calculating a discrete transformation of a concatenated segment of video data corresponding to the concatenation of the first and second segments, and

calculating a blocking artifact level, able to determine a maximum frequency predicted from the first and second segments of transformed video data, able to determine an elementary blocking artifact if a real maximum frequency of the concatenated segment of transformed video data is greater than the predicted maximum frequency, and able to count a number of elementary blocking artifacts for a set of at least one block.

Such a data processing method makes it possible to obtain a finer granularity in the detection of blocking artifacts. This is because it reliably allows the detection of elementary blocking artifacts corresponding to a segment of a block, a block comprising several horizontal and vertical segments. Then a blocking artifact level of between 0 and n is obtained, for example, for a block of n lines and m video data if all the horizontal segments of said block are taken into account, whilst the method of the state of the art gave only binary values corresponding either to the presence or absence of a blocking artifact in said block.

Another object of the present invention is a device for detecting blocking artifacts for implementing said blocking artifact detection method, in an integrated circuit for example, using hardware or software means.

### BRIEF DESCRIPTION OF THE DRAWINGS

The invention will be further described with reference to examples of embodiment shown in the drawings to which, however, the invention is not restricted.

FIG. 1 gives a schematic representation of the blocking artifact detection method according to the invention,

FIG. 2 illustrates two adjacent segments disposed on each side of a boundary separating two blocks,

FIG. 3 depicts the potential blocking artifacts for a set of one block,

FIG. 4 depicts the potential blocking artifacts for a set of four blocks,

FIG. 5 gives a schematic representation of the video data post-processing method according to the invention,

FIG. 6 gives a schematic representation of the video data coding method according to the invention, and

FIG. 7 gives three examples of the modification of a pre-encoding parameter according to said video data coding method.

### DETAILED DESCRIPTION OF AT LEAST ONE EMBODIMENT OF THE INVENTION

The present invention concerns a blocking artifact detection method. It applies to any video signal containing video data coded and then decoded according to a block-based coding technique. The coding technique is, in our example, the MPEG standard but may be any other block-based coding technique such as, for example, the standards H.261 or H.263 of the International Telecommunications Union (ITU). In the remainder of the description, the video data are preferentially the luminance values of the pixels constituting a digital image, but it will be clear to a person skilled in the art that video data such as chrominance values can also be processed by the blocking artifact detection method.

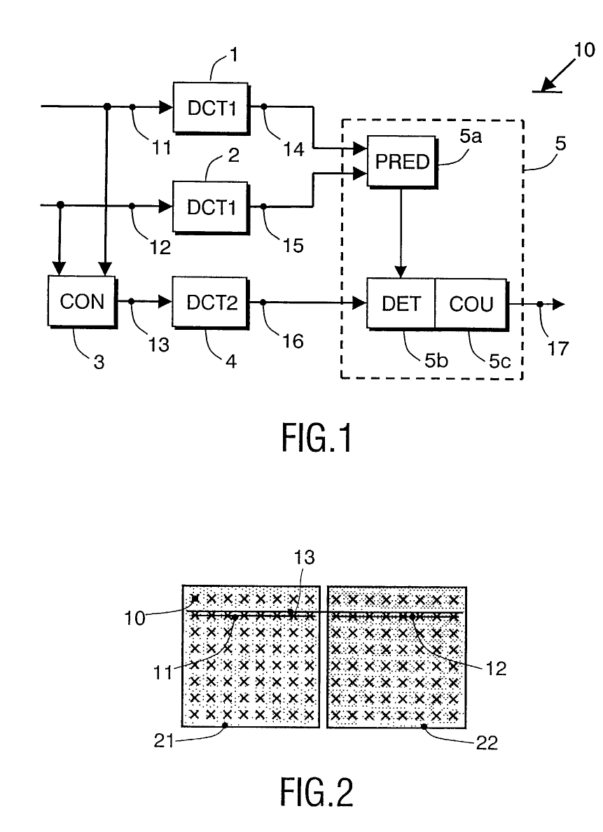

FIG. 1 describes a blocking artifact detection method according to the invention. Said method comprises the following steps.

It comprises first of all a step of calculating a first discrete transformation DCT1 (1) of a first segment u (11) of N video data (10) belonging to a first block (21), N being an integer generally equal to 8 in the case of MPEG data. These different elements are shown in FIG. 2. In our example, the discrete transformation is a discrete cosine transformation DCT but it will be clear to a person skilled in the art that the discrete transformation can be any transformation of the Fourrier type. The result of this discrete transformation is a first segment U (14) of transformed video data, such that:

U=DCT[u]={U(0), U(1), . . . , U(N−1)},

that is to say

$$U ( k ) = α ( k ) {\sum }_{n = 0}^{N - 1} u ( n ) cos ( \frac{π ( 2 n + 1 ) k}{2 N} )$$

where k is the frequency of the transformed data item U, k∈[0,N−1].

The detection method also comprises a step of calculating a second discrete transformation DCT1 (2) of a second segment of N video data (12) belonging to a second block (22), said second segment being adjacent to the first segment. The result of this discrete transformation is a second segment V (15) of transformed video data, such that:

V=DCT(v)={V(0), V(1), . . . , V(N−1)},

that is to say

$$V ( k ) = α ( k ) {\sum }_{n = 0}^{N - 1} v ( n ) cos ( \frac{π ( 2 n + 1 ) k}{2 N} ) .$$

The detection method also comprises a step of calculating a discrete transformation DCT2 (4) of a concatenated segment of 2N video data (13) corresponding to the concatenation CON (3) of the first and second segments. The result of this discrete transformation is a concatenated segment W (16) of transformed video data, such that:

W=DCT(w)={W(0), W(1), . . . , W(2N−1)},

that is to say

$$W ( k ) = \frac{1}{\sqrt{2}} α ( k ) {\sum }_{n = 0}^{2 N - 1} w ( n ) cos ( \frac{π ( 2 n + 1 ) k}{4 N} )$$

Finally, the detection method comprises a step (5) of calculating a blocking artifact level (17) according to the content of the transformed video data segments U, V and W. Said calculation step comprises a first substep PRED (5a) of determining a predicted maximum frequency kwpred from the maximum frequencies kumax and kvmax of the first and second segments U (14) and V (15) of transformed video data (14, 15) as follows:

kwpred=2.max(kumax, kvmax)+2

with

kumax=max(k∈{0, . . . ,N−1}/U(k)>T,

kvmax=max(k∈{0, . . . ,N−1}/V(k)>T,

T is a threshold strictly greater than zero, and

max is the function which gives the maximum of k from amongst a set of given values.

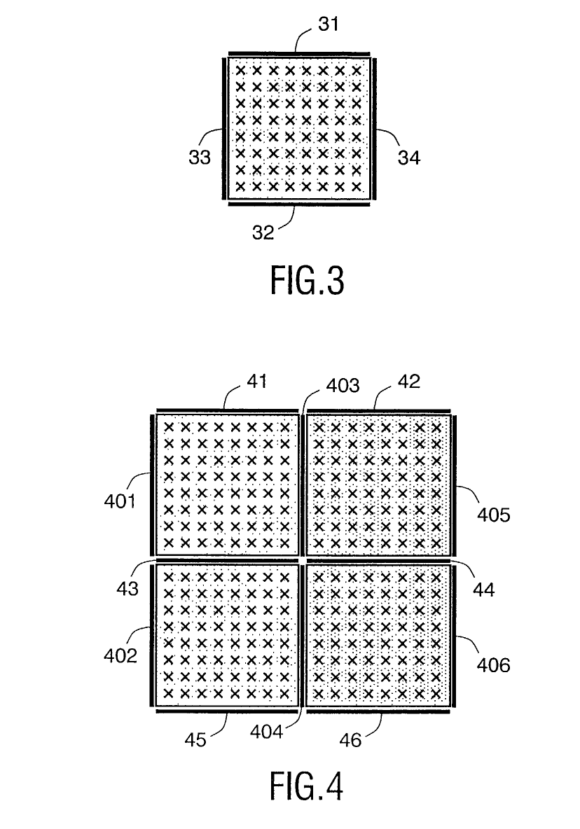

The blocking artifact level calculation step comprises a second substep DET (5b) of determining an elementary blocking artifact if the real maximum frequency kwmax=max (k∈{0, . . . , 2N−1}/W(k)>T) of the concatenated segment W (16) of transformed video data is strictly greater than the predicted maximum frequency kwpred. The blocking artifact level calculation step finally comprises a third substep COU (5c) of counting a number of elementary blocking artifacts for a set of at least one block in order to determine the level L of blocking artifacts (17). In a particularly advantageous embodiment, the set of at least one block consists of an MPEG block of 8×8 video data. The potential elementary blocking artifacts are distributed at the periphery of the MPEG block according to the diagram in FIG. 3. It may be a case of horizontal (31, 32) or vertical (33, 34) blocking artifacts. Thus the number of elementary blocking artifacts, and therefore the level L of blocking artifacts, is in this case between 0 and 32. If a block is situated at the image border, for example at the top left of the image, the method cannot detect certain elementary blocking artifacts, the horizontal blocking artifacts situated above the block and vertical blocking artifacts situated to the left of the block in the same example. The value of elementary blocking artifacts in these borders is set to zero. It is also possible to use a mirror effect and to give to said elementary blocking artifact value a value identical to that of the symmetrical elementary blocking artifact. In the preferred embodiment, the set of at least one block consists of an MPEG macroblock of 16×16 video data, that is to say 4 MPEG blocks. The potential elementary blocking artifacts are distributed at the periphery of the MPEG blocks in accordance with the diagram in FIG. 4. It may be a case of horizontal (41 to 46) or vertical (401 to 406) blocking artifacts. Thus the number of elementary blocking artifacts, and therefore the level L of blocking artifacts, is in this case between 0 and 96, which makes it possible to have a finer measurement. For a full-resolution digital image (576 lines of 720 pixels), it is then possible to construct a map representing the blocking artifact levels, this map corresponding to a matrix L(i,j) of 36 rows by 45 columns, the coefficients of which are between 0 and 96. It will be clear to a person skilled in the art that other embodiments may be advantageous, such as for example those consisting of delivering on the one hand horizontal blocking artifact levels and on the other hand vertical blocking artifact levels, thus resulting in two maps, one map representing the horizontal blocking artifact levels and one map representing the vertical blocking artifact levels. It is also possible to take account solely of certain types of blocking artifact (horizontal artifacts on the right side of a block for example) or only certain segments of a block (1 segment out of 2 for example), without for all that departing from the scope of the present invention.

The blocking artifact detection method can be implemented, in an integrated circuit for example, by virtue of hardware or software means or a combination of the two.

By way of hardware implementation, the blocking artifact detection device comprises circuits each performing a step of the blocking artifact detection method described above, the circuits for calculating a discrete cosine transformation DCT being in particular known to persons skilled in the art. Said device then comprises:

a circuit for calculating a first discrete transformation (1) of a first video data segment (11) belonging to a first block,

a circuit for calculating a second discrete transformation (2) of a second video data segment (12) belonging to a second block, said second segment being adjacent to the first segment,

a circuit for calculating a discrete transformation (4) of a concatenated segment of video data (13) corresponding to the concatenation (3) of the first and second segments and

a circuit (5) for calculating a blocking artifact level (17), able to determine (5a) a maximum frequency predicted from the first and second transformed video data segments (14, 15), able to determine (5b) an elementary blocking artifact if a real maximum frequency of the concatenated segment of transformed video data (16) is greater than the maximum frequency predicted, and able to count (5c) a number of elementary blocking artifacts for a set of at least one block.

It is also possible to implement the steps of the blocking artifact detection method by means of a suitably programmed circuit. A set of instructions contained in a programming memory can cause the circuit to perform the various steps of the blocking artifact detection method described above. The set of instructions can also be loaded into the programming memory by the reading of a data medium such as, for example, a disk which contains the set of instructions. The reading can also be performed by means of a communication network such as, for example, the Internet. In this case, a service provider will make the set of instructions available to interested parties.

The blocking artifact detection method finds many applications amongst which it is possible to cite the post-processing and in particular the coding or compression of video data.

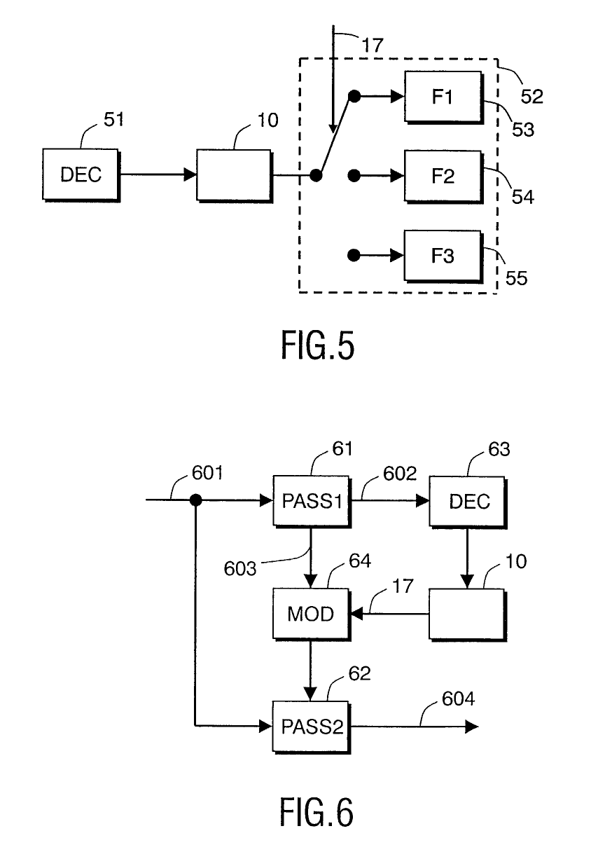

One video data post-processing method according to the invention is described in FIG. 5. It comprises the method of detecting blocking artifacts (10) previously described able to produce at least one blocking artifact level map from a flow of video data coded and then previously decoded (51). It also comprises a filtering step (52) able to apply one filter amongst a set of filters (53, 54, 55) to the set of at least one block according to its blocking artifact level (17), and resulting in a flow of filtered video data. The present invention also concerns the post-processing device for implementing said post-processing method.

In the preferred embodiment, where the set of at least one block consists of an MPEG macroblock of 16×16 video data, that is to say 4 MPEG blocks, 3 types of filtering have been defined. For a blocking artifact level less than a first predetermined threshold T1 (32 for example if 96 levels are possible), a soft filtering is applied, using for example an F1: 1/64[1 4 54 4 1] filter. Then, for a blocking artifact level lying between the first predetermined threshold T1 and a second predetermined threshold T2 (64 for example), a stronger filtering is applied, using for example an F2: 1/32[1 4 22 4 1] filter. Finally, for a blocking artifact level greater than the second predetermined threshold T2, a strong filtering is applied, using for example an F3: 1/16[1 4 6 4 1] filter. Preferably, only the video data along a block boundary are filtered. If two video data on each side of a block boundary correspond to different filters, the softer filtering is preferably chosen. It goes without saying that another division of the range of blocking artifact levels, as well as another choice of the filters, is possible.

A method of coding video data according to the invention is also described in FIG. 6. It comprises a step PASS1 (61) of pre-encoding video data (601) corresponding to an image or to a frame, said step being performed with a constant quantization step q according to a principle known to persons skilled in the art. From this pre-encoding step there results an intermediate coded video data flow (602) and pre-encoding parameters (603) such as for example the number of bits used for pre-encoding the macroblocks of the image. These pre-encoding parameters are next used during the step PASS2 (62) of coding video data (601), which delivers a final coded video data flow (602) according to a principle known to persons skilled in the art.

According to the present invention, the coded video data flow is decoded (63) and the blocking artifact detection method (10) described above is applied to the image or frame thus decoded, resulting in at least one blocking artifact level map (16). One or more pre-encoding parameters corresponding to the set of at least one block is then modified (64) according to its blocking artifact level.

In the preferred embodiment, the complexity X(i,j) resulting from the pre-encoding step, equal to the product of the quantization step and the number of bits used for the coding, and corresponding to a position macroblock (i,j) in the image, is modified as follows, resulting in a modified complexity Y(i,j):

Y(i,j)=C(L(i,j)).X(i,j)

where C is a coefficient which depends on the blocking artifact level L(i,j).

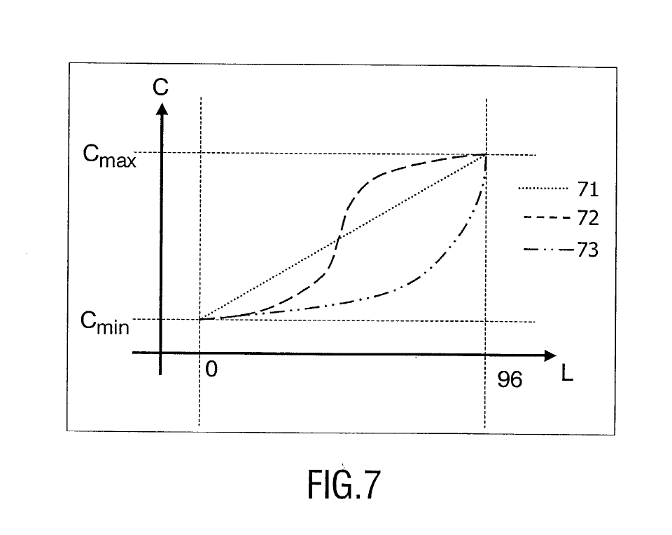

FIG. 7 gives three examples of variations in the coefficient C according to the blocking artifact level L, one linear variation (71) and two non-linear variations (72, 73) between two limits Cmin and Cmax, equal respectively to 1 and 2 for example.

The present invention also concerns the coding device for implementing said coding method.

No reference sign between parentheses in the present text should be interpreted limitingly. The verb “comprise” and its conjugations should also be interpreted broadly, that is to say as not excluding the presence not only of elements or steps other than those listed after a said verb but also a plurality of elements or steps already listed after said verb and preceded by the word “a” or “an”.

1. A method of detecting blocking artifacts (10) from video data coded and then decoded according to a block-based coding technique, characterized in that said method comprises the steps of:
calculating a first discrete transformation (1) of a first video data segment (11) belonging to a first block,
calculating a second discrete transformation (2) of a second video data segment (12) belonging to a second block, said second segment being adjacent to the first segment,
calculating a discrete transformation (4) of a concatenated segment of video data (13) corresponding to the concatenation (3) of the first and second segments, and
calculating (5) a blocking artifact level (17), able to determine (5a) a maximum frequency predicted from the first and second segments of transformed video data (14, 15), able to determine (5b) an elementary blocking artifact if a real maximum frequency of the concatenated segment of transformed video data (16) is greater than the predicted maximum frequency, and able to count (5c) a number of elementary blocking artifacts for a set of at least one block.

2. A video data coding method comprising a pre-encoding step (61), a decoding step (63), and a blocking artifact detection method (10) as claimed in claim 1, from video data pre-encoded and then decoded, as well as a step of modifying at least one pre-encoding parameter corresponding to the set of at least one block according to the blocking artifact level (17) of said set.

3. A video data post-processing method comprising a blocking artifact detection method (10) as claimed in claim 1, as well as a filtering step (52) able to apply one filter amongst a set of filters (53, 54, 55) to the set of at least one block according to its blocking artifact level (17).

4. A device for detecting blocking artifacts (10) from video data coded and then decoded according to a block-based coding technique, characterized in that said device comprises:
means of calculating a first discrete transformation (1) of a first video data segment (11) belonging to a first block,
means of calculating a second discrete transformation (2) of a second video data segment (12) belonging to a second block, said second segment being adjacent to the first segment,
means of calculating a discrete transformation (4) of a concatenated segment of video data (13) corresponding to the concatenation (3) of the first and second segments, and
means of calculating (5) a blocking artifact level (17), able to determine (5a) a maximum frequency predicted from the first and second segments of transformed video data (14, 15), able to determine (5b) an elementary blocking artifact if a real maximum frequency of the concatenated segment of transformed video data (16) is greater than the predicted maximum frequency, and able to count (5c) a number of elementary blocking artifacts for a set of at least one block.

5. A video data coding device comprising a pre-encoding unit (61), a decoding unit (63), and a blocking artifact detection device (10) as claimed in claim 4, from video data pre-encoded and then decoded, as well as means of modifying at least one pre-encoding parameter corresponding to the set of at least one block according to the blocking artifact level (17) of said set.

6. A video data post-processing device comprising a blocking artifact detection device (10) as claimed in claim 4, as well as a filtering unit (52) able to apply one filter amongst a set of filters (53, 54, 55) to the set of at least one block according to its blocking artifact level (17).

7. A “computer program” product in particular for coding video data comprising a set of instructions which, when they are loaded into a data processing circuit of said video coder, causes said circuit to implement the blocking artifact detection method according to claim 1.
